(19) United States
(12) Patent Application Publication
(10) Pub. No.: US 2015/0100361 A1
(43) Pub. Date: Apr. 9, 2015

(54) IN-CONTEXT OILFIELD PROCESS DOCUMENTATION SYSTEM AND METHOD

(71) Applicant: SCHLUMBERGER TECHNOLOGY CORPORATION, Sugar Land, TX (US)

(72) Inventors: Julian Jose Moreno, Huixquilucan (MX); Diego Tortella, Valldoreix (ES)

(21) Appl. No.: 14/498,591

(22) Filed: Sep. 26, 2014

Related U.S. Application Data
(60) Provisional application No. 61/886,163, filed on Oct. 3, 2013.

(51) Int. Cl. G06Q 10/06

(52) U.S. Cl. CPC G06Q 10/063114
USPC 705/7.15

(57) ABSTRACT

Methods, computer-readable media, and computing systems for process management. The method includes receiving a project from an organizer. The project includes a plurality of tasks. The method also includes causing data representative of a first task of the plurality of tasks to be displayed on a first worker workstation, in an interface that is in-context with a visualization displayed by executing a first oilfield software application. The method also includes receiving a completion report for the first task from the first worker workstation, using the interface.

### CROSS-REFERENCE TO RELATED APPLICATIONS

This application claims priority to U.S. Provisional patent application having Ser. No. 61/886,163, filed on Oct. 3, 2013, the entirety of which is incorporated herein by reference.

### BACKGROUND

Workflows are organized and implemented to formalize, track, and understand processes involving multiple steps and complex participation among workers. In a manufacturing setting, for example, workflows may be somewhat rigid and inflexible. In geoscience or engineering contexts, in contrast, workflow changes may occur rapidly, due to changing hardware or software capabilities, new methodologies, etc. As such, some processes may be conducted out-of-order, and coordination among project members may take multiple paths toward completion.

Furthermore, geoscience or engineering workflows may be challenging to properly document because different software technology or oilfield software applications may be used in the execution of the workflows. One challenge may be capturing of the workflow progress in the context of the associated technology and data, and making geoscientist and engineers aware of the workflow progress in the context of oilfield software applications.

Business process management systems (BPMS) and content management systems (CMS) have been introduced and partially address such challenges. A BPMS may be an organization of business processes within an entity, with the goal of aligning the entity's business processes with the wants and needs of its clients. A CMS may include software applications or suites thereof that enable publishing, editing, and modifying content, as well as maintenance from a central interface. The CMS software may also provide procedures to manage workflow in a collaborative environment.

### SUMMARY

Embodiments of the disclosure may provide a computer-implemented method for process management. The method includes receiving a project from an organizer. The project includes a plurality of tasks. The method also includes causing data representative of a first task of the plurality of tasks to be displayed on a first worker workstation, in an interface that is in-context with a visualization displayed by executing a first oilfield software application. The method also includes receiving a completion report for the first task from the first worker workstation, using the interface.

Embodiments of the disclosure may also provide a non-transitory computer-readable medium storing instructions that, when executed by at least one processor of a computing system, cause the computing system to perform operations. The operations include executing an oilfield software application using a first workstation. Executing the oilfield software application causes a visualization to be displayed using the first workstation. The operations may also include receiving, at the first workstation, data representing a plurality of tasks associated with a project, and displaying, using the first workstation, an open task including at least one of the plurality of tasks. The open task is displayed in an interface that is in-context with the visualization. The operations also include performing, using the first workstation, the open task using the oilfield software application, and transmitting a completion report associated with the open task to the business process management system, an organizer workstation, or both, using the interface.

Embodiments of the disclosure may also provide a computing system including a first workstation. The first workstation includes one or more processors, a display, and a memory system. The memory system includes one or more non-transitory, computer-readable media storing instructions that, when executed by the one or more processors, cause the first workstation to perform operations. The operations include executing an oilfield software application using the one or more processors. Executing the oilfield software application causes a visualization to be displayed using the display. The operations also include receiving, at the first workstation, data representing a plurality of tasks associated with a project, and displaying, using the display, an open task comprising at least one of the plurality of tasks. The open task is displayed in an interface that is in-context with the visualization. The operations also include performing the open task using the oilfield software application, and transmitting a completion report associated with the open task to the business process management system, an organizer workstation, or both, using the interface.

The foregoing summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a schematic view of a system for managing oilfield project workflows, according to an embodiment.

FIGS. 2A and 2B illustrate visualizations of execution of an oilfield software application, including an in-context interface, according to an embodiment.

FIG. 3 illustrates a visualization of a dashboard for project management, including an out-of-context interface, according to an embodiment.

FIG. 4 illustrates a flowchart of a method for managing oilfield project workflows, according to an embodiment.

FIG. 5 illustrates a schematic view of a processor system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

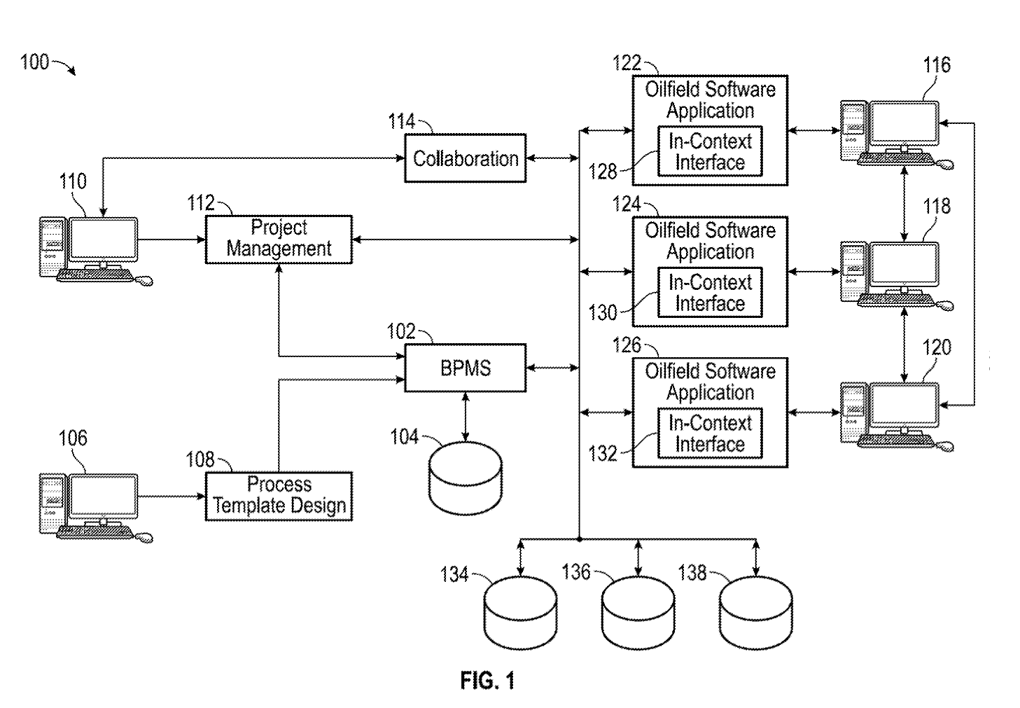

FIG. 1 illustrates a conceptual schematic view of a system 100 for managing oilfield project workflows, according to an embodiment. It will be appreciated that the system 100 may be tailored for other uses, with oilfield project workflows being but one intended use among many contemplated. As will be described in greater detail below, embodiments of the system 100 may provide for organization and execution of oilfield software tasks. As the term is used herein, “oilfield software tasks” broadly refers to activities undertaken to support exploration, production, or other oilfield tasks, which are performed using one or more software applications, e.g., software specifically tailored for oilfield use (e.g., “oilfield software applications”). Examples of such software packages include PETREL®, AVOCET®, PIPESIM®, OLGA®, and TECHLOG®, which are all commercially available from Schlumberger Technology Corporation. Any other such oilfield software, available from other developers, vendors, etc. may also or instead be employed.

The system 100 may include a business process management system (BPMS) 102, which may also be referred to as a BPMS engine, according to an embodiment. The BPMS 102 may be or include one or more computers, workstations, servers, etc. The BPMS 102 may include or otherwise communicate with a BPMS database 104. The BPMS 102 may store one or more business process templates in the database 104. The templates may specify one or more workflows, which may include tasks to be completed to achieve a certain goal, such as completing an oilfield project. The templates may also provide profiles of attributes that are suggested for workers that may be assigned to the various tasks. The attributes may specify recommended qualifications, competency, etc., of such workers, which may be employed to complete the associated task. The BPMS 102 may also provide one or more dashboards, as will be described in greater detail below, which may provide information related to project assignments, task progress, hierarchy, etc., which may facilitate project organization.

The system 100 may also include a template designer workstation 106. The template designer workstation 106 may communicate with the BPMS 102. Further, a template designer may employ the template designer workstation 106 to develop, modify, create, etc. one or more project templates, as indicated at block 108. The project templates may specify one or more workflows for conducting a project, suggested roles or qualifications for workers undertaking tasks associated with the workflows, etc. The template designer workstation 106 may provide the project templates to the BPMS 102, which may then, e.g., evaluate and/or store the template in the database 104.

The system 100 may also include one or more organizer workstations 110. The organizer workstation 110 may be employed by a manager or another type of user, e.g., to initiate, coordinate, monitor, supervise, etc. one or more projects, as indicated at block 112. The organizer workstation 110 may be in communication with the BPMS 102. Accordingly, the organizer workstation 110 may enable an organizer, using the organizer workstation 110, to select a project template, e.g., stored on the database 104. The organizer using the organizer workstation 110 may associate the template with a specific project, e.g., by name, client, geography, etc. The organizer, e.g., still using the organizer workstation 110, may also associate the tasks contained in the template with workers, e.g., according to experience, expertise, credentials, education, availability, or other attributes, e.g., as may be suggested by the template.

In addition to such project management at 112, the organizer workstation 110 may facilitate collaboration among a plurality of team members, as indicated at block 114. Such collaboration may proceed via email, text messaging, instant messaging, teleconference, videoconference, etc., whether in-context or out-of-context of an oilfield software application (as will be described below). The organizer workstation 110 may enable an organizer, using the organizer workstation 110, to direct queries, documents, or other information or requests for information to an appropriate location, or respond directly to such requests, as appropriate.

The system 100 may also include a plurality of worker workstations (three shown: 116, 118, and 120). In an embodiment, the worker workstations 116-120 may be in communication with the BPMS 102, the organizer workstation 110, and with one another. Each of the worker workstations 116-120 may also execute one or more oilfield software applications (three shown: 122, 124, and 126). The oilfield software applications 122-126 may be, for example, PETREL®, AVOCET®, TECHLOG®, OLGA®, PIPESIM®, etc. Further, the oilfield software applications 122-126 may be representative of the same or different applications.

The oilfield software application(s) 122-126 may be of different types, e.g., employed by a worker at one or more of the workstations 116-120 to conduct processing tasks related to different tasks in oilfield exploration, simulation, and/or production. For example, such tasks may include well planning, basin modeling and/or simulation, fluid flow modeling and/or simulation, well logging, seismographic interpretation, etc. In some embodiments, oilfield software applications may include exploration, development, and production applications, which may support any oilfield operations and workflows, including exploration, completion, production, and abandonment, and/or others.

It will be appreciated that, in some situations, the workstations 116-120 may be coupled with a cloud computing environment, where a remote computer may execute at least part of the oilfield software applications 122-126 and provide data which is visualized on the workstations 116-120 to display. Such remote execution and local visualization proceeds by interaction of a worker with the workstation 116-120, and at least some execution of instructions (e.g., to provide the visualization) by the workstation 116-120. Thus, this arrangement is considered within the scope of the workstations 116-120 “executing” the oilfield software application(s) 122-126 (or, the application being “executed on” the workstation(s) 116-120), for purposes of this disclosure.

The respective workstations 116-120 may also provide an in-context interface 128, 130, 132. The in-context interfaces 128-130 may be a window that is displayed within the oilfield software application 122-126, i.e., within or juxtaposed with one or more windows of the oilfield software application 122-126. In some cases, the in-context interfaces 128-130 may be the same, regardless of what type of oilfield software application(s) is/are executing on a particular workstation 116-120. As the term is used herein, “in-context” as it relates to a display or interface in the oilfield software application(s) means that the display or interface is seen along with or in a visualization displayed by executing an oilfield software application, e.g., within or juxtaposed with a working interface of the oilfield software application (e.g., where the tasks are performed using the oilfield software application(s)). In some cases, the in-context interfaces 128-132 may be configured to appear automatically when the workstations 116-120 begin executing the oilfield software applications 122-126.

The system 100 may also include a document management database 134, an oilfield data database 136, and a plug-in database 138, which may each be coupled with one or more of the BPMS 102, the organizer workstation 110, and/or the worker workstations 116-120. The document management database 134 may contain files, reports, summaries, etc., generated using the oilfield software applications. The oilfield data database 136 may include data collected, measured, calculated, or modeled, whether from seismic data, well-logging data, other geologic sources, simulations, etc. The plug-in database 138 may include one or more applications that may be executed as part of the oilfield software applications 122-126, e.g., to extend the functionality thereof.

The in-context interfaces 128-132 may provide a communications link (portal) for interacting with the BPMS 102. For example, the in-context interfaces 128-132 may receive data representing task information, e.g., from the organizer workstation 110 and/or the BPMS 102 and display such information in-context with the oilfield software application 122-126. In an embodiment, the in-context interfaces 128-132 may receive workflow information about the tasks, including the identity of to whom the various tasks are assigned, whether the tasks have been completed, and expected/assigned completion date, among others. The in-context interfaces 128-132 may then display this information in the context of the oilfield software applications

The in-context interfaces 128-132 may also provide a communications link between the worker workstations 116-120, e.g., to facilitate collaboration among the workers. In situations where a workflow specifies that completion of one task by one worker is a predicate for beginning or completing another task by a second worker, the second worker may track the progress and/or completion status of the first worker on the predicate task.

The in-context interfaces 128-132 may further provide a communications link for transmitting an indication of task completion from the workstations 116-120 to the BPMS 102 and/or to the organizer workstation 110. The in-context interfaces 128-132 may provide for such a “report-out” functionality, and may provide fillable fields providing a completion date, comments, and locations of files (e.g., in the document management database 134) that may have been generated during performance, or by completion, of the tasks.

When the BPMS 102 receives a task completion indication (in embodiments in which it does), the BPMS 102 may notify the organizer workstation 110. For example, the BPMS 102 may provide or communicate with an out-of-context display, which may be accessible to or otherwise displayed by the organizer workstation 110. The out-of-context display may include the same or similar information as one or more of the in-context interfaces 128-132. In particular, in an embodiment, the out-of-context display may provide an indication of to whom one or more tasks are assigned, their credentials, education, background, etc., as well as the status of the task (e.g., completed, in-progress, not started, not yet assigned, etc.).

Moreover, the organizer (using the organizing workstation 110) and/or the BPMS 102 may modify the project workflow and/or task assignments based on the report-outs received. For example, the report-out may indicate that circumstances, e.g., in the oilfield, have been uncovered during the tasks that cause the organizer to modify the workflow. Further, new technological developments may warrant changing workflows. In addition, the report-out may indicate that a different worker (e.g., with greater or lesser expertise) is better suited for the task, and the organizer and/or the BPMS 102 may reassign the task. Such information may also be relayed to the designer workstation 106 for template modification. When the organizer and/or the BPMS 102 modifies the workflow, the organizer workstation 110 and/or the BPMS 102 may send out modified task information to the worker workstations 116-120, which may display the modified task information.

In addition, the report-out functionality may provide for advancing in the workflow. Certain tasks may include making a decision between two or more routes to a project goal, or may serve as predicates to performing a subsequent task. Accordingly, upon a report out of a completion of one task, the organizer and/or BPMS 102 may advance in the workflow and, e.g., assign, activate, or otherwise indicate one or more different tasks to one or more of the workers at the workstations 116-120.

The BPMS 102 may also search the plug-in database 138 for one or more plug-ins which may be suitable for performing or facilitating performance of one or more tasks using the oilfield software application. For example, the plug-ins may be searched based on the oilfield software application, user profile (e.g., education, type of user (e.g., geologist, engineer, etc.), credentials, etc.). Further, one or more searches may be tailored for guiding use of the oilfield software application. The searches may be determined based on the task being performed, type of user, education, credentials, etc. The search results may suggest actions, instructions, publications, workers with similar experience, and/or any other resources that may be helpful to the worker in performing one or more tasks using the oilfield software application.

It will be appreciated that the various workstations described herein may be separate and/or remote from one another, e.g., as in a cloud computing or networked environment. Further, in some embodiments, two or more of such workstations may be integrated into a single workstation, server, virtual machine, cloud processor, physical machine or processor, etc., without departing from the scope of the present disclosure.

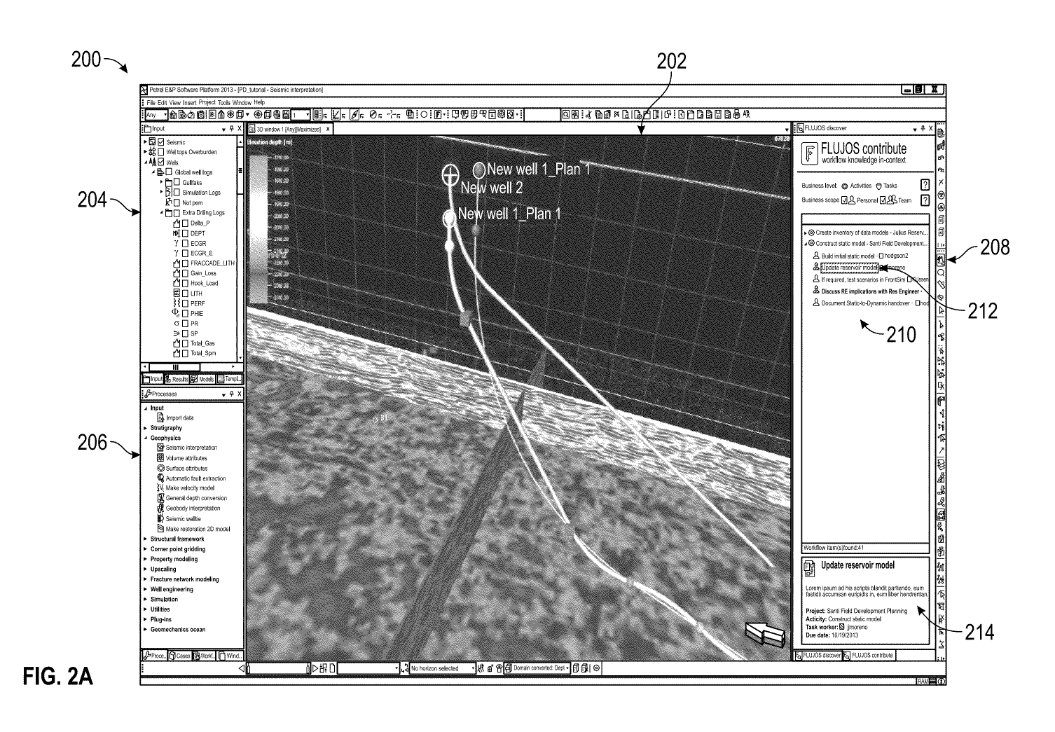

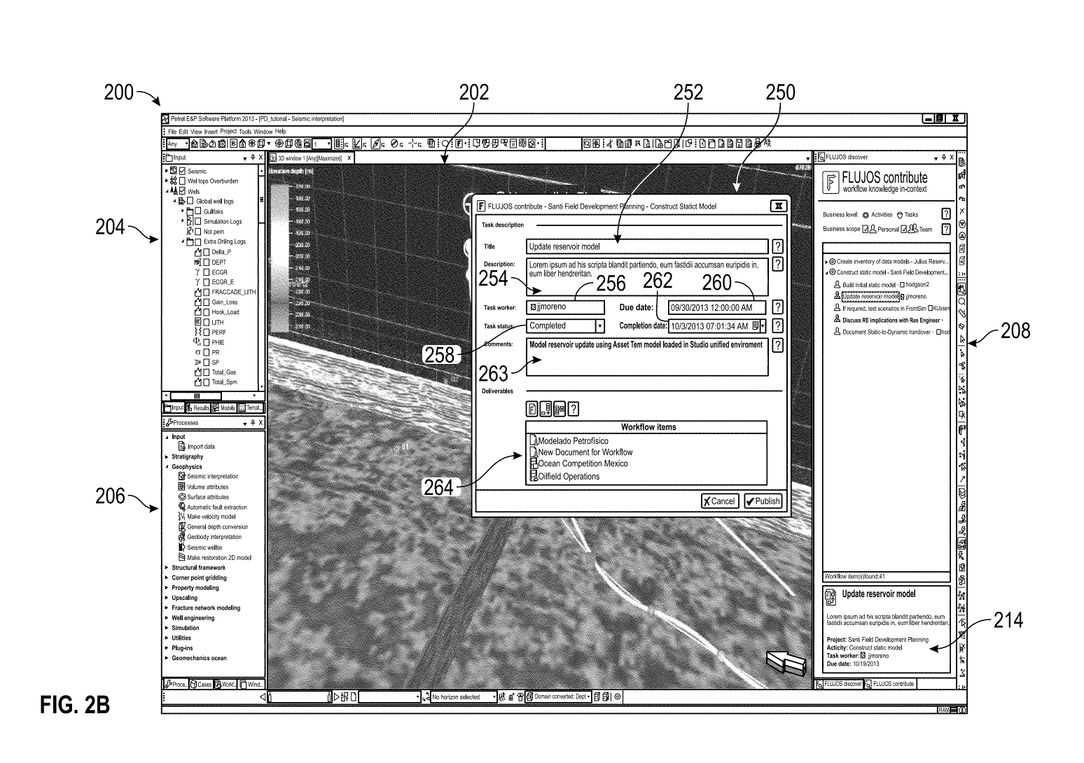

FIG. 2A illustrates a visualization 200 displayed in association with (e.g., by execution of) an oilfield software application, according to an embodiment. The visualization 200 may include a plurality of windows 202, 204, 206. A user at a workstation executing the oilfield software application may be able to view the visualization 200 and may interact therewith via the windows 202-206, e.g., to accomplish an assigned task. For example, the window 202 may be a working window. In various embodiments, the working window 202 may display seismic data, geologic models, well plans, well logs, well sections, piping systems, simulations, etc. depending, e.g., on the type of oilfield software application employed.

The window 204 may, for example, include a menu of inputs, e.g., data files that may be used to at least partially create the displays in the working window 202. Further, the window 206 may include a menu of processes that may be conducted, e.g., using the inputs, with the process and/or the results of the process being displayed in the working window 202. It will be appreciated that a variety of other windows may be included in the visualization 200 or otherwise displayed as part of executing the oilfield software application. Accordingly, the illustrated visualization 200 and windows 202-206 is not intended to be limiting.

Further, an in-context interface 208 may be displayed, e.g., as part of the visualization 200. The in-context interface 208 may specify one or more tasks 210 to be completed. In association with the tasks 210, the in-context interface 208 may display a task status indicator 212, which may indication whether a task is completed, ready to be completed (e.g., all predicate tasks completed), in progress, not yet assigned, etc. Moreover, the in-context interface 208 may include an indication of the workers assigned to the tasks 210, e.g., by indicating the identity (e.g., username, as shown, name, ID number, etc.) next to the task 210.

The in-context interface may also provide a secondary window 214, which may display additional details about the task currently being performed using the oilfield software application (the execution of which provides the visualization 200). The additional details may include a project type, an activity or task currently being performed using the oilfield software application, an identity of the worker, and a due date for the task completion.

Referring now to FIG. 2B, when a task is completed, the in-context interface 208 may additionally provide a report-out window 250. The report-out window 250 may include a plurality of fillable fields, which may provide information useful to other workers, organizers, clients, etc. The report-out window 250 may, for example, include a title field 252, which may include a descriptive title of the project, task, or both. The report-out window 250 may also include a description field 254. The worker may fill in the description field 254 with a description of the task completed. Further, other fields 256, 258, 260, 262 may provide a worker identity, a task status, a due date, and a completion date, respectively, for tracking progress of the project. The report-out window 250 may also provide a comments field 263, in which comments, e.g., related to the completion and/or performance of the task 210 may be entered. Further, the report-out window 250 may provide an attachment window 264, which may include links to, publications of, or otherwise provide an indication of one or more files or deliverables created as part of performing the task.

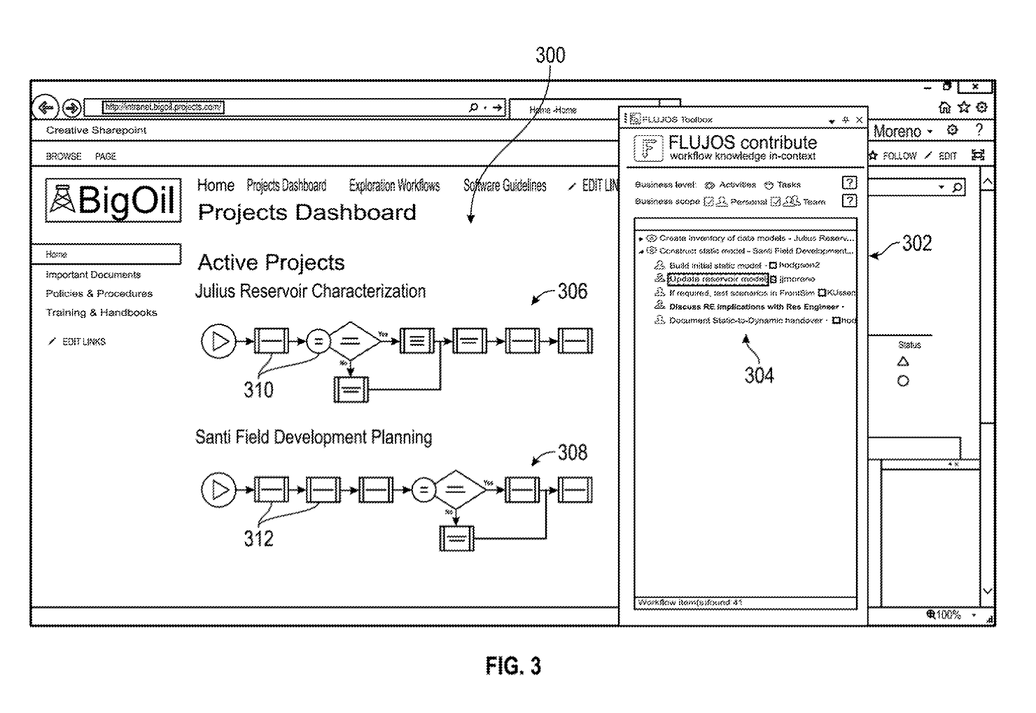

FIG. 3 illustrates a view of a project dashboard 300, which may include an out-of-context interface 302, according to an embodiment. The out-of-context interface 302 may be characterized as out-of-context because tasks 304 referenced therein are not completed by executing the software that results in the dashboard 300. Rather, the tasks 304 are completed by interaction with other oilfield software applications.

The dashboard 300 may provide a graphical, textual, etc. view of project workflows, e.g., for active projects. Two such workflows 306, 308 are provided. Each of the workflows 306, 308 include tasks 310, 312, respectively, which may be linked to the tasks 304 displayed in the interface 302. Accordingly, by selecting (e.g., clicking on, hovering a cursor over, etc.) one of the tasks 310, 312, the associated task 304 may be highlighted or otherwise indicated in the interface 302. Additional details about the task 304 may then be displayed, either by such selection of the tasks 310, 312 or by direct selection of one of the tasks 304.

With additional reference to FIG. 1, the out-of-context interface 302 may be displayed on the organizer workstation 110. For example, the out-of-context interface 302 may be updated via interaction with the BPMS 102. In turn, the BPMS 102 may interact with the in-context interfaces 128-132 to provide such updates to the out-of-context interface 302. Accordingly, the BPMS 102 may receive updates regarding a plurality of potentially different types of oilfield software applications 122-126 and provide the updates to the organizer via the dashboard 300 and the out-of-context interface 302. Further, the organizer may use the dashboard 300 to modify or update the workflows 306, 308, e.g., by clicking-and-dragging the blocks representing the tasks 310, 312 of the workflows 306, 308, adjusting for decisions made during the progression of the workflows 306, 308, importing new workflows, etc. These updates or modifications may be automatically imported into the out-of-context interface 302, which may provide the updates/modifications, e.g., directly or via the BPMS 102, to the in-context interfaces 128-132 displayed at the worker workstations 116-120 as part of the visualizations 200 (FIG. 2).

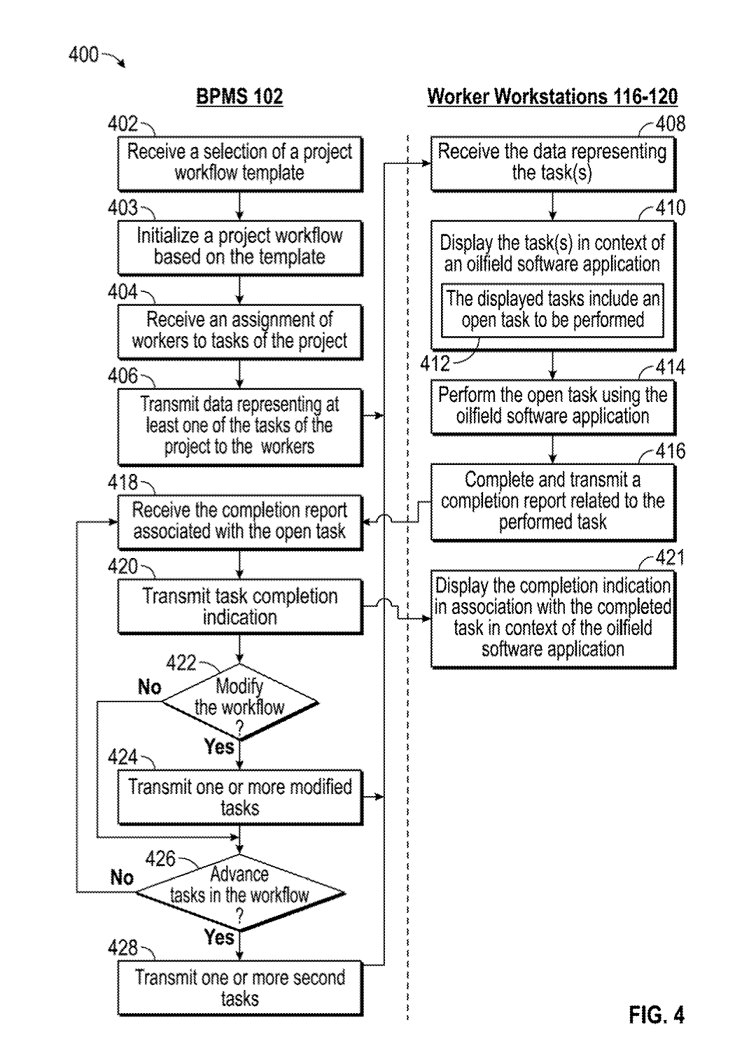

With additional reference to FIG. 1, FIG. 4 illustrates a flowchart of a method 400 for managing oilfield tasks, according to an embodiment. The method 400 may proceed by operation of the BPMS 102 and one or more of the worker workstations 116-120. In at least some embodiments, however, at least some portions of the method 400 may be performed by the organizer workstation 110, e.g., through interaction with the organizer (e.g., a human user) without departing from the scope of the present disclosure. For purposes of illustration, however, the method 400 is described herein as proceeding by interaction between the BPMS 102 and the worker workstations 116-120.

The method 400 may include the BPMS 102 receiving a selection of a project workflow template, as at 402, e.g., from the organizer workstation 110. In response, the BPMS 102 may fetch the template from the database 104 and initialize a new project workflow based on the template and data related to the project received, e.g., from the organizer workstation 110, as at 403. The project workflow may include a plurality of tasks, e.g., oilfield processing tasks, such as modeling, simulating, and/or interpreting data (seismic, well log, etc.), which may be conducted using one or more of the oilfield software applications 122-126.

The method 400 may then include receiving an assignment of workers to the project tasks, as at 404, e.g., from the organizer workstation 110. The workers may be assigned based on a profile (e.g., expertise, credentials, education, experience, etc.) which may be stored in the BPMS 102 or anywhere else (employee databases, human resources, etc.), and/or availability, or any other factor.

The method 400 may then proceed to the BPMS 102 transmitting data representing at least some of the tasks of the project to at least one of the worker workstations 116-120, as at 406. The transmission of data from the BPMS 102 to the worker workstations 116-120 may be direct and according to any process or transmission protocol of electronic communication (email, text, posting to a website, TCP/IP, etc.). In other embodiments, the transmission of data from the BPMS 102 may be routed through the organizer workstation 110, which may review and/or relay the data to the worker workstations 116-120.

In an embodiment, the BPMS 102 may send all or some of the tasks of the project to the worker workstations 116-120 at 406. The tasks may be sent out in stages, e.g., with completion of one stage of tasks being a predicate for sending and/or performing the next stage. Further, different tasks may be sent to the different worker workstations 116-120, e.g., depending on relevance to the worker, group of workers, type of worker (e.g., geologist, engineer, etc.), etc. relevant to the tasks or to which the tasks is assigned.

The worker workstations 116-120 (e.g., the worker workstation 116, as shown) may receive the data indicative of the one or more tasks sent by the BPMS 102 (and/or the organizer workstation 110), as at 408. The worker workstations 116-120 may then display the received tasks in-context in one or more oilfield software applications, as at 410. For example, different worker workstations 116-120 may execute different oilfield software applications tailored to different types of tasks. The displaying at 410 may include displaying the tasks in an in-context interface, an example of which is discussed above with reference to FIG. 2. The in-context interface may display the tasks in association with various other information, such as identity of the workers assigned to the tasks, completion indicators, expected date of completion, and/or the like, as described in greater detail above. In an embodiment, at least one of the tasks received by at least one of the worker workstations 116-120 may be uncompleted and assigned to a worker associated with the workstation 116. This may be referred to as an “open” task, as at 412.

The method 400 may then proceed to performing the open task using the oilfield software application (e.g., in which the in-context interface is displayed), as at 414. Once the task is completed, the method 400 may include completing and transmitting a completion report related to the performed (previously-open) task, as at 416, to the BPMS 102. It will be appreciated that various intermediate progress reports may also be prepared and/or transmitted, e.g., to the BPMS 102 and/or the organizer workstation 110, according to various embodiments.

The BPMS 102 may receive the completion report associated with the task, as at 418. The BPMS 102 may then transmit a task completion indication to one or more of the workstations 116-120, as at 420. The task-completion indication may be transmitted, for example, to each of the worker workstations 116-120 to which data representative of the task was transmitted at 406. The worker workstation 116 may then display the completion indication in association with the completed task and in-context with the oilfield software application, as at 421. For example, in the embodiment of FIG. 2, the status indicator 212 of the in-context interface 208 may change to indicate that the task 210 has been completed. Thus, the status of the tasks 210 in the project may be updated on one, some, or all (e.g., those to which it is deemed relevant) of the worker workstations 116.

The BPMS 102 may also provide an indication of task completion to the organizer workstation 110, e.g., as part of the dashboard 300 discussed above with reference to FIG. 3. In response, the organizer workstation 110 may also determine, or receive a determination of, whether to modify the workflow, as at 422, e.g., based on the completion report received at 418. Such modification determination may occur automatically, e.g., in response to input received from the completion report received at 418. In other cases, the modification determination may occur after consideration by one or more human users. If it is determined to modify the workflow, the organizer workstation 110 may receive the modification and transmit the modification to the BPMS 102, e.g., using the dashboard 300. Further, if the tasks of the workflow are modified, e.g., to change assignments, order of performance of the tasks, add tasks, etc., one or more modified (including new) tasks may be established as part of the workflow. These modified tasks may be assigned to one or more worker(s) and transmitted, as at 424, to the worker workstation 116-120 for completion, as at 408.

The method 400 may also include the BPMS 102 advancing tasks in the workflow, e.g., in response to the completion report being received, as at 426. For example, some tasks (e.g., in this instance, “second tasks”) may require earlier, predicate tasks to be completed beforehand. The completion report may indicate that the predicate task or tasks have been completed and, in response (as determined at 426), the BPMS 102 may release the second tasks to the worker workstations 116-120 for completion, as at 428.

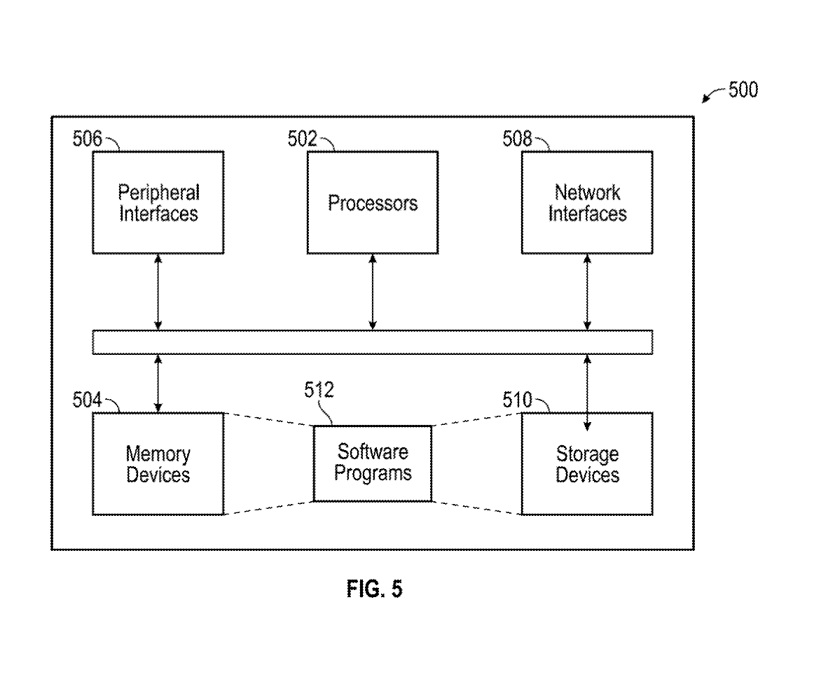

Embodiments of the disclosure may also include one or more systems for implementing one or more embodiments of the method 400. FIG. 5 illustrates a schematic view of such a computing or processor system 500, according to an embodiment. Embodiments of the various workstations 110 and 116-120 and/or the BPMS 102 may be or include embodiments of the processor system 500 and/or two or more of the workstations 110 and 116-120 may be provided by a single processor system 500.

The processor system 500 may include one or more processors 502 of varying core configurations (including multiple cores) and clock frequencies. The one or more processors 502 may be operable to execute instructions, apply logic, etc. It will be appreciated that these functions may be provided by multiple processors or multiple cores on a single chip operating in parallel and/or communicably linked together. In at least one embodiment, the one or more processors 502 may be or include one or more GPUs.

The processor system 500 may also include a memory system, which may be or include one or more memory devices and/or computer-readable media 504 of varying physical dimensions, accessibility, storage capacities, etc. such as flash drives, hard drives, disks, random access memory, etc., for storing data, such as images, files, and program instructions for execution by the processor 502. In an embodiment, the computer-readable media 504 may store instructions that, when executed by the processor 502, are configured to cause the processor system 500 to perform operations. For example, execution of such instructions may cause the processor system 500 to implement one or more portions and/or embodiments of the method(s) described above.

The processor system 500 may also include one or more network interfaces 506. The network interfaces 506 may include any hardware, applications, and/or other software. Accordingly, the network interfaces 506 may include Ethernet adapters, wireless transceivers, PCI interfaces, and/or serial network components, for communicating over wired or wireless media using protocols, such as Ethernet, wireless Ethernet, etc.

As an example, the processor system 500 may be a mobile device that includes one or more network interfaces for communication of information. For example, a mobile device may include a wireless network interface (e.g., operable via one or more IEEE 802.11 protocols, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

The processor system 500 may further include one or more peripheral interfaces 508, for communication with a display screen, projector, keyboards, mice, touchpads, sensors, other types of input and/or output peripherals, and/or the like. In some implementations, the components of processor system 500 need not be enclosed within a single enclosure or even located in close proximity to one another, but in other implementations, the components and/or others may be provided in a single enclosure. As an example, a system may be a distributed environment, for example, a so-called “cloud” environment where various devices, components, etc. interact for purposes of data storage, communications, computing, etc. As an example, a method may be implemented in a distributed environment (e.g., wholly or in part as a cloud-based service).

As an example, information may be input from a display (e.g., a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

The memory device 504 may be physically or logically arranged or configured to store data on one or more storage devices 510. The storage device 510 may include one or more file systems or databases in any suitable format. The storage device 510 may also include one or more software programs 512, which may contain interpretable or executable instructions for performing one or more of the disclosed processes. When requested by the processor 502, one or more of the software programs 512, or a portion thereof, may be loaded from the storage devices 510 to the memory devices 504 for execution by the processor 502.

Those skilled in the art will appreciate that the above-described componentry is merely one example of a hardware configuration, as the processor system 500 may include any type of hardware components, including any necessary accompanying firmware or software, for performing the disclosed implementations. The processor system 500 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 500 may be used to execute programs according to instructions received from another program or from another processor system altogether. Similarly, commands may be received, executed, and their output returned entirely within the processing and/or memory of the processor system 500. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A computer-implemented method for process management, comprising:
receiving a project from an organizer, wherein the project comprises a plurality of tasks;
causing data representative of a first task of the plurality of tasks to be displayed on a first worker workstation, in an interface that is in-context with a visualization displayed by executing a first oilfield software application; and
receiving a completion report for the first task from the first worker workstation, using the interface.

2. The method of claim 1, further comprising receiving one or more template projects from a designer workstation, wherein receiving the project from the organizer comprises receiving a selection of one of the one or more template projects.

3. The method of claim 1, wherein receiving the project from the organizer comprises receiving assignments of at least some of the plurality of tasks to a plurality of workers.

4. The method of claim 1, further comprising:
modifying the project based on the completion report for the first task, such that one or more modified tasks are generated; and
transmitting data representing the one or more modified tasks to the first worker workstation.

5. The method of claim 1, wherein:
receiving the completion report comprises receiving the completion report from the first worker workstation, wherein the first task is completed using the first worker workstation; and
causing an indication that the first task has been completed to be displayed on a second worker workstation, in-context with a visualization displayed by executing a second oilfield software application on the second workstation.

6. The method of claim 5, wherein the first and second oilfield software applications are configured to conduct different types of oilfield software tasks.

7. The method of claim 1, wherein receiving the completion report comprises receiving data associated with one or more files created in association with performing the first task.

8. The method of claim 1, further comprising:
updating a project workflow in response to receiving the completion report; and
in response to updating the project workflow, causing data indicative of a second task to be displayed on the first worker workstation, in-context with the visualization, wherein completion of the first task is a predicate to performing the second task.

9. The method of claim 1, wherein the plurality of tasks comprise one or more geological exploration tasks, one or more oilfield production tasks, one or more reservoir simulations, one or more basin modeling, one or more pipe flow simulations, one or more well planning, one or more well logging, or one or more combinations thereof.

10. A non-transitory computer-readable medium storing instructions that, when executed by at least one processor of a computing system, cause the computing system to perform operations, the operations comprising:
executing an oilfield software application using a first workstation, wherein executing the oilfield software application causes a visualization to be displayed using the first workstation;
receiving, at the first workstation, data representing a plurality of tasks associated with a project;
displaying, using the first workstation, an open task comprising at least one of the plurality of tasks, the open task being displayed in an interface that is in-context with the visualization;
performing, using the first workstation, the open task using the oilfield software application; and
transmitting a completion report associated with the open task to the business process management system, an organizer workstation, or both, using the interface.

11. The medium of claim 10, further comprising displaying a second open task in the interface, wherein the second open task is to be performed using a second workstation.

12. The medium of claim 11, wherein the second open task is to be completed by a second oilfield software application that is configured for completing a different type of oilfield task than the oilfield software application executing on the first workstation.

13. The medium of claim 11, further comprising receiving data indicating that the second open task has been completed, wherein performing the open task is in response to receiving the data indicating that the second open task has been completed.

14. The medium of claim 13, wherein receiving the data indicating that the second open task has been completed comprises receiving one or more files generated by performing the second open task.

15. The medium of claim 10, further comprising receiving data representing an association between a plug-in available for the oilfield software application in an application database and the open task.

16. The medium of claim 15, wherein the association is further based on a user profile associated with the oilfield software application, a user associated with the first workstation, the first workstation, or both.

17. The medium of claim 10, wherein the completion report includes data representing one or more files generated by performing the open task.

18. The medium of claim 10, further comprising:
receiving one or more modified tasks from the business process management system, wherein the one or more modified tasks are modified based on the completion report;
displaying the one or more modified tasks using the interface; and
performing the one or more modified tasks using the oilfield software application.

19. A computing system, comprising:
a first workstation comprising one or more processors, a display, and a memory system, the memory system comprising one or more non-transitory computer-readable media storing instructions that, when executed by the one or more processors, cause the first workstation to perform operations, the operations comprising:
executing an oilfield software application using the one or more processors, wherein executing the oilfield software application causes a visualization to be displayed using the display;
receiving, at the first workstation, data representing a plurality of tasks associated with a project;
displaying, using the display, an open task comprising at least one of the plurality of tasks, the open task being displayed in an interface that is in-context with the visualization;
performing the open task using the oilfield software application; and
transmitting a completion report associated with the open task to the business process management system, an organizer workstation, or both, using the interface.

20. The system of claim 19, further comprising a second workstation that is configured to communicate with the first workstation, wherein a second open task displayed in the interface is to be performed using a second workstation.
